(19) United States
(12) Patent Application Publication
(10) Pub. No.: US 2007/0294723 A1
(43) Pub. Date: Dec. 20, 2007

(54) METHOD AND SYSTEM FOR DYNAMICALLY INSERTING MEDIA INTO A PODCAST

(75) Inventors: JOSEPH L. DVORAK, BOCA RATON, FL (US); STUART S. KREITZER, CORAL SPRINGS, FL (US); CHARLES P. SCHULTZ, NORTH MIAMI BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/424,556

(22) Filed: Jun. 16, 2006

(51) Int. Cl. H04N 7/10; H04N 7/025

(52) U.S. Cl. 725/35

(57) ABSTRACT

A system (160) and method (400) is provided for podcast quoting. The method can include quoting (410) a segment from a media source to produce a quoted segment (399), creating (420) a specification (500) for the quoted segment, and inserting (430) the quoted segment into a podcast (306) in accordance with the specification. A source (302) of the quoted segment, a start time (311), an end time (322), and an insertion point (333) can be included in the specification.

### FIELD OF THE INVENTION

The present invention is relates to multimedia and, more particularly, to methods of mobile content distribution.

### BACKGROUND

The use of portable electronic devices and mobile communication devices has increased dramatically in recent years. Mobile communication devices such as cell phones and portable media players are capable of establishing multimedia communication with other communication devices over landline networks, cellular networks, and, recently, wide local area networks (WLANs). Such devices are capable of distributing various forms of media to a general audience, such as digital multi-media files. This can include a podcast, which is a method of distributing multimedia files, such as audio programs or music videos, over the Internet for playback on mobile devices and personal computers. Users can post media files on a website that can be automatically downloaded to podcast listeners. The podcast listeners can “tune-in” to a podcast on their computer or mobile device. The podcast can be an episode of a show, a newscast event, or a blog.

Podcast episodes are typically audio or video files that are uploaded and hosted on a webserver. The podcast episodes are accompanied by a file known as a feed. The feed file contains lists of podcast episode URL's along with publish dates and descriptive information on the podcast. Typically the feeds are created in RSS (Really Simple Syndication) or Atom format. The podcast listener enters the address of the feed into their podcast receiver which could be a PC, PDA, mobile phone or other device. The podcast receiver which is also commonly called an aggregator or podcatcher periodically downloads the feed and checks if a new episode of the podcast is available. If a new episode that has not already been downloaded is available, the aggregator will download the episode using the URL listed in the feed.

In contrast, blogs (web logs) are generally web-based publications consisting primarily of periodic articles and events which are frequently updated. Bloggers (web loggers) can post directly to the publication thereby providing a medium for people to form on-line communities. Blogs provide a means for people to converse in on-line “running conversations” or “threads”. Threads are topical connections between messages on a Blog, which generally focus on a particular subject, such as food, politics, or local news, or a persons diary. On-line publication technology has matured to an extent where people can post to a blog in a rather accessible manner. Web interfaces providing on-line access allow people to blog from anywhere on the Internet. Information can be directly posted to the blog in a rather straight forward manner. Other people can add to the blog by providing textual comments for each individual blog entry—thus creating an “annotation” of the blog. Whereas blogs are text based, podcasts are a combination of audio, video, and text. In practice, podcasts are downloaded and played on a local device, and blogs are viewed in a browser. With regard to distribution, podcasts are copies of files that can be downloaded to a device, though blogs are presented only as a single file from a server. Podcasts do not readily provide a means for third person or subscriber annotation. A need therefore exists for annotating a podcast.

### SUMMARY

Embodiments of the invention are directed to a method for inserting a quoted segment into a podcast. The method can include quoting a segment from a media source, creating a specification of the quoted segment, and inserting the quoted segment into the podcast. A mobile device can feed the quoted segment into the podcast in accordance with the specification. The specification can instruct a rendering of the quoted segment. For example, the specification can identify the media source, a start time of the quoted segment, an end time of the quoted segment, a time length of the quoted segment, and an insertion point into the second podcast. The specification can also include a byte length of the quoted segment, which can be used to calculate the overall size of the annotated content. The byte length can be used to estimate download time and storage calculation. If the mobile device cannot retrieve the media, the mobile device assigns a quoted segment duration of zero to indicate a missing portion. In one arrangement, the specification can be included as metadata in the second podcast.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of a mobile communication environment;

FIG. 2 is a schematic of a multimedia device in accordance with the embodiments of the invention;

FIG. 3 is a diagram of a podcast interface in accordance with the embodiments of the invention;

FIG. 4 is a method for podcast quoting in accordance with the embodiments of the invention;

FIG. 5 is a specification for a quoted segment in accordance with the embodiments of the invention;

FIG. 6 is a method for creating a specification in accordance with the embodiments of the invention; and

FIG. 7 is a method for inserting a quoted segment in a second podcast in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as any number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention provide a method and system for quoting a segment of a media and inserting the segment into a podcast. Quoting a segment can be defined as identifying a portion of media within a podcast and extracting the portion from the media. A quoted segment can be inserted into the podcast in accordance with a specification. A quoted segment is a portion of media extracted from a podcast. The portion of media can be data from an audio, video, or text file. The specification identifies a source of the media, a start time of the quoted segment in the media, an end time of the quoted segment in the media or a length of the quoted segment. The specification can be a text document of file identifying attributes of the quoted segment. For example, the specification can be in XML format for identifying attributes and values. The quoted segment is an extracted portion of a podcast which can correspond to a voice clip, a media clip, an audio clip, a video clip, or a text segment. The specification can also identify an insertion point for inserting the quoted segment into the podcast. For example, a user of a mobile device can quote a segment of media and insert the segment into a podcast. The user can quote a segment by specifying start or stop times on the mobile device. The user can then specify an insertion point of the quoted segment into the podcast.

In one arrangement, the media can be downloaded from a source such as a server which provides access to audio, video, or text data. In another arrangement, the address of the source can be identified, and referenced in the specification. The specification can be stored as metadata in the second podcast. Podcasters can feed the quoted segment into the podcast in accordance with the specification. For example, the specification can describe the source of the quoted segment and how to retrieve the quoted segment from the source during a delivery of the podcast. The method can include tracking a time during the delivery of the podcast, comparing the time with a list of the quote insertion times, and inserting the quoted segment when the time corresponds to a quote insertion time. This allows one or more quoted segments to be included in the podcast.

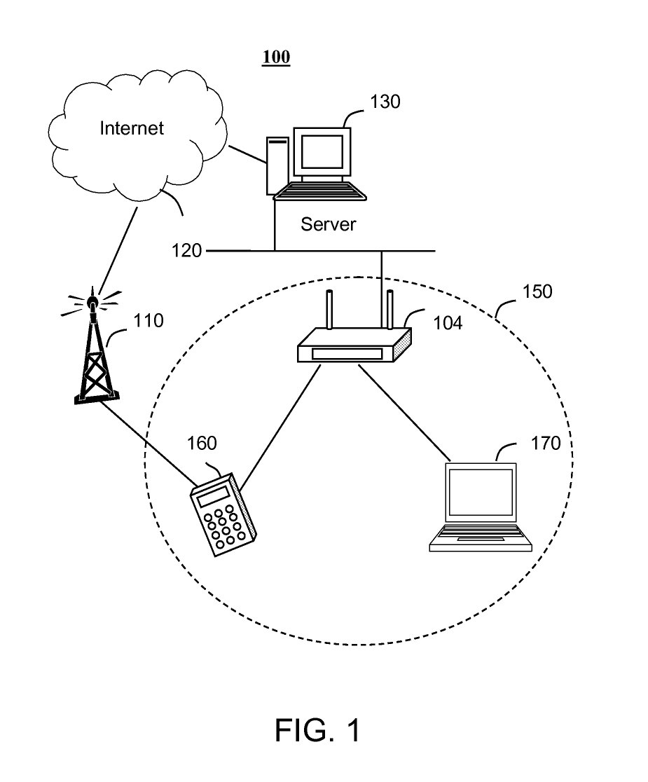

Referring to FIG. 1, a mobile communication environment 100 is shown. The mobile communication environment 100 can provide wireless connectivity over a radio frequency (RF) communication network or a Wireless Local Area Network (WLAN). Communication within the network 100 can be established using a wireless, copper wire, and/or fiber optic connection using any suitable protocol (e.g., TCP/IP, HTTP, etc.). In one arrangement, a mobile device 160 can communicate with a base receiver 110 using a standard communication protocol such as CDMA, GSM, or iDEN. The base receiver 110, in turn, can connect the mobile device 160 to the Internet 120 over a packet switched link. The Internet 120 can support application services and service layers for providing media or content to the mobile device 160. The mobile device 160 can also connect to other communication devices through the Internet 120 using a wireless communication channel. The mobile device 160 can establish connections with a server 130 on the network and with other mobile devices 170 for exchanging data and information. The server can host application services directly, or over the Internet 120.

The mobile device 160 can also connect to the Internet 120 over a WLAN. Wireless Local Access Networks (WLANs) provide wireless access to the mobile communication environment 100 within a local geographical area. WLANs can also complement loading on a cellular system, so as to increase capacity. WLANs are typically composed of a cluster of Access Points (APs) 104 also known as base stations. The mobile communication device 160 can communicate with other WLAN stations such as the laptop 170 within the base station area 150. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 160 can send and receive data to the server 130 or other remote servers on the mobile communication environment 100.

The mobile device 160 can be a cell-phone, a personal digital assistant, a portable music player, or any other suitable communication device. The mobile phone 160 and the laptop 170 can be equipped with a transmitter and receiver for communicating with the AP 140 according to the appropriate wireless communication standard. In one embodiment of the present invention, the wireless station 160 is equipped with an IEEE 802.11 compliant wireless medium access control (MAC) chipset for communicating with the AP 140. IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

The mobile device 160 can send and receive media to and from other devices within the mobile communication environment 100 over the WLAN connection or the RF connection. In one example, the mobile device 160 can connect to the server 130 for receiving one or more podcasts. The mobile device 160 can transmit and receive data packets containing audio, text, or video from the server 130 through a podcast website hosted on the server 130. The server 130 can send media to the mobile devices 160 for downloading a podcast. Alternatively, the mobile device 160 can communicate with the laptop 170 over a peer-to-peer network for receiving and transmitting podcasts. The term “podcast” can mean both the content and the method of delivery.

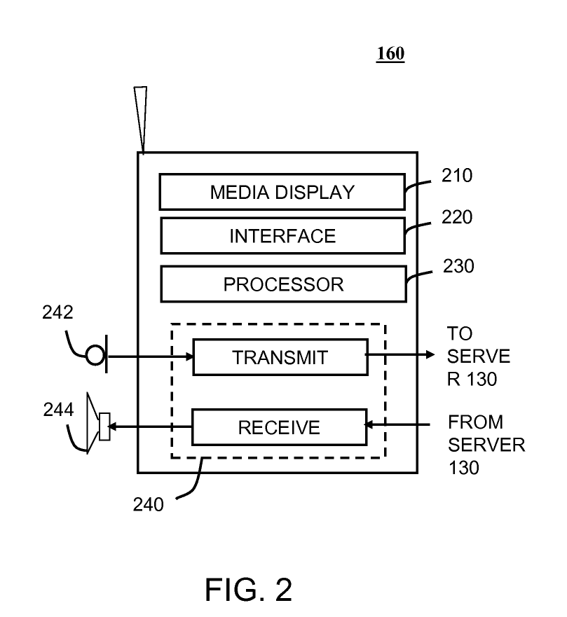

Referring to FIG. 2, a mobile device 160 for podcasting is shown. The mobile device 160 can include a media display 210 for presenting one or more podcasts, an interface 220 for quoting and inserting a segment of a media and creating a specification to the portion, and a processor 230 for rendering the podcasts in accordance with a specification. The term rendering is defined as any process associated with including a quoted segment into a podcast. The process can include inserting a section of media or inserting a reference to a section of media. Rendering can include smoothing a transition between a first podcast and a quoted segment, wherein the smoothing occurs at the boundaries of the insertion. The mobile device 160 can also include a communications unit 240 having a transmit module and receive module for receiving media and presenting the one or more podcasts to the media unit 210. The transmit and receive modules are not novel to the invention. The communication unit 240 can support packet data and establish a communication link to one or more media sources, such as the server 130, for providing a connection to a Universal Resource Indicator (URI), a hyper transfer text protocol (HTTP) address, or an Internet Protocol (IP) address. In practice, a quoted segment can be inserted from a first podcast into a second podcast. The processor 230 can be a microprocessor or DSP that can perform signal processing functions for capturing or presenting a podcast.

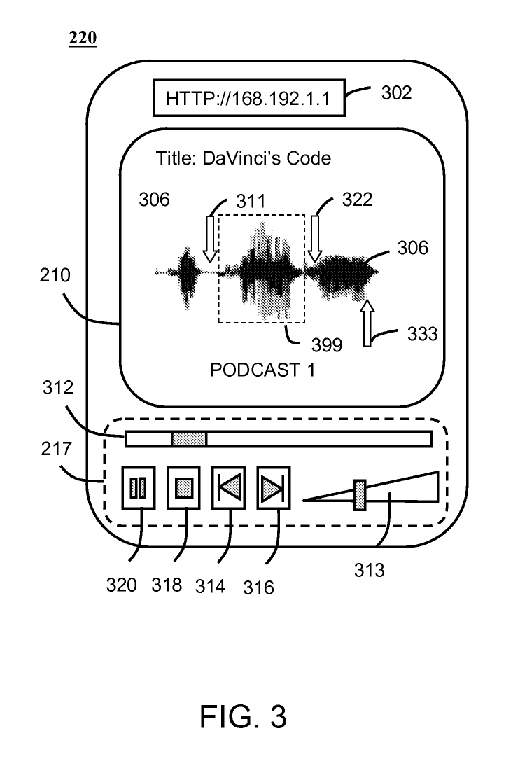

Referring to FIG. 3, the media display 210 and the interface 220 of the mobile device of FIG. 1 are shown in greater detail. The interface 220 can include an address bar 302 for entering an address of a podcast, and a selector panel 217 for quoting and inserting a segment of media into a podcast. The media display 210 can present a podcast 306 in an audio format (shown), video format (not shown), and/or text format (not shown). The selector 217 can include one or more compositional tools (314-320), or authoring tools, for quoting a segment of a podcast. For example, the selector 217 can include a begin quote button 314, an end quote button 316, a save/insert quote button 318, and a pause button 320. The save/insert button 318 can be used to capture a quote segment from a media source and also insert the quote segment in a podcast. The pause button 320 can be used to determine an insertion point in the podcast 306. The interface 220 can also include a timer 312 for displaying a time of the media in the podcast 306. The timer 312 can include options for adjusting the media time resolution. For example, increasing or decreasing the duration of media presented on the media display 210. The timer can provide zooming functionality for adjusting a view of the media content. For example, audio can be displayed as a time varying waveform that moves across the media display 210 as shown. The timer 312 can adjust the length of the audio presented in the media display 210. The timer 312 can also provide an estimate of a time length of a podcast quote by numerically displaying the time. The selector panel 217 can also include a volume selector 313 for adjusting a volume of the podcast 306.

One aspect of the invention is directed towards quoting a segment of a podcast. The podcast can be saved with a specification as a quoted segment and later retrieved for insertion in a second podcast. The specification can include instructional information for inserting one or more quoted segments in the podcast 306. For example, the specification can include a list of quote insertion times which the mobile device 160 can scan for identifying one or more quote insertion times. Understandably, the selector 217 and the media display 210 work in conjunction to provide a visual context and a quoting means for extracting a segment of media and thereafter inserting the quoted segment into the podcast 306. The selector 217 allows a user can scan to a certain point within a podcast and mark a start time 311 or an end time 322, to capture a quoted segment. Understandably, embodiments of the invention are not limited to the arrangement of components, nor the function of the components shown in FIG. 3. The interface 220 can include more or less than the number of components shown which are presented independently for illustrating their function.

The media between the start time 311 and the end time 322 is the quoted segment 399. The timer 312 provides a progress function which allows a user to identify a time line of the quoted segment. The user can begin capture at the start time 311 by depressing the quote button 314, end capture at the end time 322 by depressing the end quote button 316, and save the quote segment by depressing the save/insert quote button 318. The saved quoted segment 399 can be retrieved at a later time for insertion into a second podcast. The components, such as the quote buttons 314-316 in the selector 217 can be integrated into a single button or software feature. For example, a navigation pad can be used to consolidate the button functions and allow a user to scan ahead or back in the podcast to quote a segment. The navigation pad can be employed for other uses, such as switching between podcasts, or selectively activating one or more podcasts in the media display 210.

A second aspect of the invention is directed to inserting a quoted segment into a second podcast. For example, a user can download a podcast from a server, and upon viewing the podcast, pause the podcast at a point of insertion. The user can then insert a quote segment from another podcast or media source. For example, the user can enter the address of a media source providing the quoted segment, and insert the quoted segment at the insertion point in the podcast. The quoted segment may correspond to a quoted segment the user captured or a quoted segment another user previously captured and uploaded to a server. The user can enter in a Universal Resource Indicator (URI), a hyper transfer text protocol (HTTP) address, or an Internet Protocol (IP) address into the address bar 302 to receive one or more quote segments. The quoted segments may be from audio files, video files, or text clips that are not part of a podcast. That is, embodiments of the invention are not limited to capturing quoted segments from only podcasts. Other media sources can be identified for extracting quoted segments and inserting quoted segments.

Other means for receiving quotes segments over the Internet are herein contemplated, and are not limited to the address scheme provided. For example, the mobile device 160 can receive media from one or more podcasters through communication ports or interfaces. A podcaster may be a server 130 that hosts media on one or more websites. The server 130 can send media to the mobile device 160 for presenting the podcast. In one aspect, the podcaster (e.g. information provider such as the server 130) chooses which files to offer in a feed to the mobile device 160. A feed is a buffer which can hold data, such as audio, video, or text data, and which includes mechanisms for inserting, updating, and moving the data along the buffer. For example, data can be placed on a feed for providing data to a media consumer. Data can also be linked into the feed via reference or hyperlink. The server can establish broadcast times, such as daily news times, for podcasting the media. The user can then select which media to receive among available feed channels provided by the podcaster. For example, the user may elect to receive only a few episodes of a podcast from one or many episodes pushed by the server 130. The user can “channel” in to certain episodes of a broadcast. The server 130 may send one or more blogs for podcast which can be downloaded by the mobile device 160. The blogs may be transmitted to the mobile device in an audio, text, or video format.

In another aspect, the server 130 may stream one or more blogs for podcast. The blogs may be transmitted to the mobile device in a streaming media format which can include audio, text, or video. That is, a podcast can be downloaded from the webserver and played immediately on the mobile or fixed device without being stored. Some mobile phones will use this method to avoid the need to store content locally in the phone. Streaming media is continuous media that is provided to the mobile device 160 and is consumed while it is being delivered. That is, the media is presented as it is received, and the media is not saved. In one aspect, streaming media can be provided through an open communication connection from the server 130 to the mobile device. The communication path stays open and packets of data are streamed over the connection and consumed by the mobile device during rendering of the media. For example, the mobile device 160 can open a socket connection to the server 130 for receiving streaming media and present the data as it is received. Streaming is notably different from opening a connection, downloading a media file, storing the media file, closing the connection, opening the media file, and then playing the media file. Accordingly, it is also different, for similar reasons, from publishing a blog to a website which retains content, or data. That is the, blog can be edited since it is stored and not consumed.

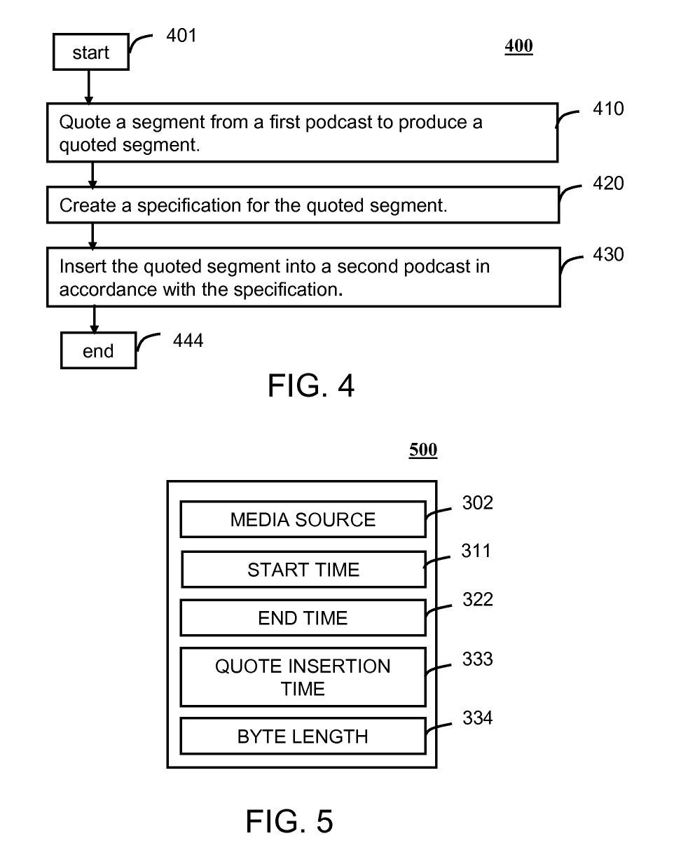

It should be noted that podcasts are in general downloaded and locally stored prior to playback. Streaming media is an alternate form of media delivery herein contemplated and not limited by this invention. Accordingly, quoting a podcast that is streamed requires a form of quoting that takes into account the consuming nature of streaming media. Briefly, quoting a streaming podcast involves capturing a segment of streamed media during a presentation of the podcast. The segment can be captured by download or reference. For example, the media can be downloaded and saved locally. Or, an address to the media can be saved as a reference, and the media can be streamed from the address when needed. Referring to FIG. 4, a method 400 for podcast quoting is shown. The method 400 can be practiced with more or less than the number of steps shown. To describe the method 400, reference will be made to FIG. 3 although it is understood that the method 400 can be implemented in any other suitable device or system using other suitable components. Moreover, the method 400 is not limited to the order in which the steps are listed in the method 400. In addition, the method 400 can contain a greater or a fewer number of steps than those shown in FIG. 4.

At step 401, the method 400 can start. The method 400 can start in a state wherein a user is playing a first podcast for selecting a portion to insert into a second podcast. For example, referring to FIG. 3, the user can enter a URI into the address bar 302 to receive a first podcast 306. The first podcast can be presented on the media display 210 for allowing the user to select a segment to insert into the podcast. Notably, capturing a quoted segment and inserting the quoted segment do not have to be sequential. That is, the user can capture a quoted segment at a first time, and at a later time insert the quoted segment into a second podcast. In addition, the user is not required to capture the quoted segment. For example, other users can upload quoted segments which can be made available to a general audience. The user can use these quoted segments to insert into a second podcast.

In one arrangement, the second podcast is composed. For example, the user may compose the second podcast by extracting media from the first podcast 306 or other podcasts and inserting the media into the second podcast. Understandably, the interface 220 allows the user to alternate between different podcasts, extract media from the different podcasts, and insert the media into various podcasts. The interface 220 provides a compositional environment for media development and podcast quoting. For example, a user can be playing the second podcast while referring back to the first podcast to capture one or more quoted segments. That is, the user can pause the second podcast, switch to the first podcast, capture a quoted segment from the first podcast, switch back to the second podcast, and insert the quoted segment in the second podcast. The first and second podcasts may be locally stored on the mobile device, or they may be streamed. It should be noted that the terminology for “first” podcast is the podcast from which the quoted segment is captured, and the “second” podcast is the podcast to which the quoted segment is inserted.

In another example, a user can use the mobile device for voice dictation and insert quoted segments from one or more media sources or podcasts into the dictation. The mobile device 160 can capture the voice and append the quoted segment to the voice. The quoted segment can be included in the dictation directly, or a reference link to the quoted segment can be included at a corresponding location of the insertion point. The mobile device can quote the segment into the dictation for composing the second podcast. In one arrangement, a specification of the quoted segment can be included as meta data within the second podcast that links in the quoted segment from one or more media sources.

At step 410, a segment of the first podcast can be quoted to produce a quoted segment. For example, referring to FIG. 3, the user can visualize media from the podcast as it is presented on the media display 210. The user can select a segment of the first podcast 306 by selecting a start time and a stop time. For example, the selector 217 provides an ability for scanning to certain time positions in a podcast. The user can adjust the timer 312 to demarcate the start time 311 in a first podcast, and the end time 322 in the first podcast. The selector 217 can be software configurable or hardware configurable. Upon selecting the start time 311, the user can depress the begin quote button 314 to begin media capture of the quoted segment 399. Upon selecting an end time 322, the user can depress the end quote button 316 to end media capture. The media between the start time 311 and the end time 312 corresponds to the quoted segment 399. In one implementation, the start time 311 and the end time 322 can be saved as metadata within the file (for example, in the ID3 tags of a media file). The processor 230 (see FIG. 2) can terminate capture and save the quoted segment to a file, such as an audio file, text file, or video file. Alternatively, the processor can store an address of the media. Audio formats can include .mpeg, .wav, pcm, .oog, and voice encoding formats such as vselp, ambe, celp, amr, and the like. The media can be stored in compressed format or non-compressed format. In one arrangement, the media can be played back to the user for allowing the user to listen to, or see, the quoted segment 399.

Upon capturing the quoted segment 399, the user can identify one or more insertion points for the quoted segment 399 in the second podcast. Again, the user is not required to capture the quoted segment. For example, the user can download the quoted segment from a server. During insertion, the user can scan to a position in the second podcast and identify an insertion point 333. Notably, the insertion point 333 is shown within the first podcast only for principles of illustration. That is, the quoted segment may not be inserted in the same podcast from which it was captured. The quoted segment can be inserted into other podcasts. For example, the interface 220 can present the second podcast (not shown) and the user can select the insertion point 333 in the second podcast. The user can select the insertion point 333 by hitting the insert quote button 318. Understandably, the search and select methods employed for selecting the quoted segment 399 and inserting the quoted segment are not limited to the selector 217. The functions can be combined in a navigation pad and various means for performing the search and select are herein contemplated, which can include switching between podcasts.

At step 420, the specification can be created. The insertion point 333, the media source 302 of the quoted segment, the start time 311 and end time 322 of the quoted segment, can be included in the specification. A byte length of the quoted segment can also be included in the specification. Notably, the specification provides time and location information for feeding the quoted segment 399 during a delivery of the second podcast. Briefly referring to FIG. 5, the specification 500 is shown. The specification 500 can include the media source 302, the start time 311, the end time 322, the quote insertion time 333, and the byte length 334, but is not herein limited to these. The specification 500 can include more or less attributes than those shown. The media source 302 can be a data file containing the quoted segment, or a reference link to a source of media providing the quoted segment. In the latter, the start time 311 and the end time 322 can specify the location of the quoted segment in the media provided by the media source 302. The quote insertion time 333 can correspond to the insertion point of the quoted segment 399 in the second podcast. The specification 500 can be included as meta data within the second podcast or as a separate file. The specification 500 can inform a podcaster where to retrieve the media of the quoted segment, the start and end times of the quoted segment in the media, and an insertion point for inserting the quoted segment into a second podcast.

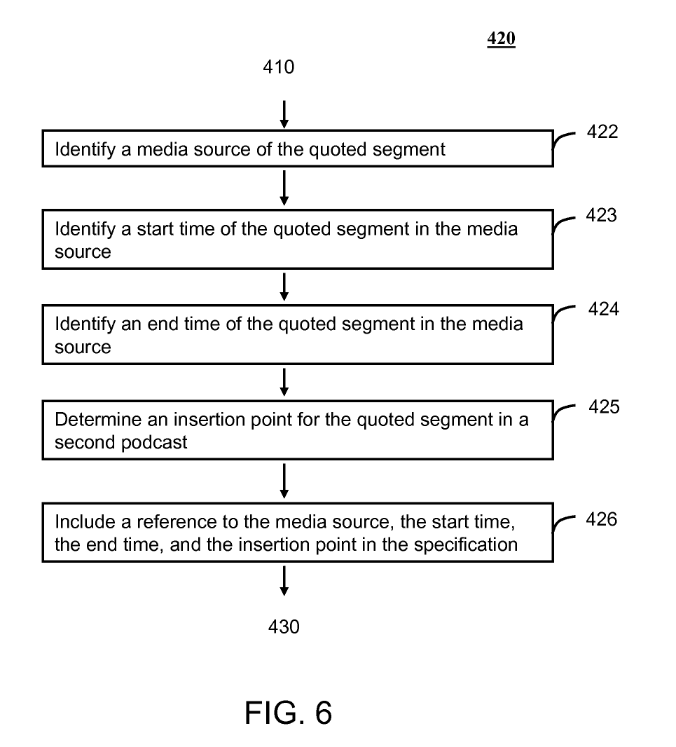

Briefly referring to FIG. 6, one or more steps of creating the specification 500 in accordance with the description of FIGS. 3 and 4 is shown. At step 422, the media source of the quoted segment 399 is identified. The media source is identified by the URI in the address bar 302 (See FIG. 3). Understandably, the source of media may arrive from other websites linked by the URI. As is known in the art, files can be referenced by hyperlink or through XML pages for downloading content. At step 423, a start time (311) of the quoted segment 399 in the media source is identified. At step 424, an end time (322) of the quoted segment 339 in the media source is identified. At step 425, the insertion point (333) for the quoted segment in a second podcast is determined. And, at step 426, the reference (302) to the media source of the quoted segment 399 is included in the specification 500. Alternatively, the quoted segment 399 may be included from a podcast subscription list provided by the user. For example, the user may have a podcast subscription list from which one or more quoted segments can be extracted.

At step 430, the quoted segment can be inserted into the second podcast in accordance with the specification. Notably, the specification 500 describes how a quoted segment from a first podcast can be inserted into a second podcast. In one aspect, the specification 500 provides this information which can be included as metadata in a second podcast. In practice, a podcaster client (e.g. mobile device) can retrieve the specification 500 from the metadata and feed the quoted segment in the second podcast in accordance with the specification 500. The specification can be included as part of the download of the second podcast, such as metadata. Alternatively, the specification can be downloaded with the second podcast as a separate file. Note, the method step 430 can be a standalone step, apart from steps 410 to 420. That is, the step of inserting the quoted segment 430 can occur at a later time, upon a download of the second podcast. For example, the user can select a quoted segment from a first podcast and specify an insertion point in a second podcast. Information in regards to the quoted segment can be stored in the specification and included as meta data in the second podcast. The quoted segment can be inserted during a delivery of the second podcast which may occur at a later date. Notably, the specification 500 describes how the quoted segment is inserted during a delivery of the second podcast.

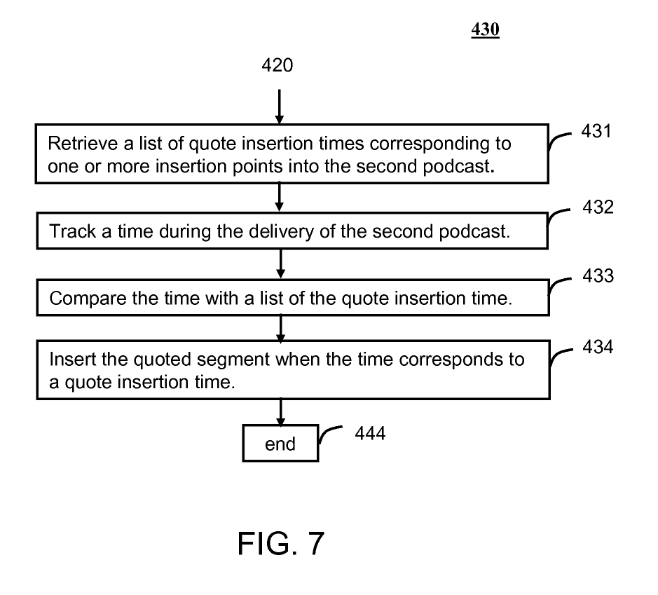

During a delivery of the second podcast, or subsequently after the podcast is received and stored, the podcast client (mobile device) can check for any quote segment insertion times listed in the specification 500, or metadata. Upon identifying a quote insertion time, the mobile device can download the quoted segment in accordance with the specification 500. For example, at step 431 of FIG. 7, a list of quote insertion times corresponding to one or more insertion points in the second podcast can be retrieved. At step 432, a time can be tracked during the delivery of the second podcast. For example, the interface 220 can use the timer 312 to track the playback of the second podcast. At step 433, the time can be compared with the list of quote insertion times. For example, the interface 220 can compare the current time of the timer 312 with quote insertion times in the list of quote insertion times. At step 434, the quoted segment can be inserted when the time corresponds to the quote insertion time. Similarly, the quote insertion list can include locations for inserting the quoted segment. For example, the location can be specified by a number of samples referenced from the beginning of the media. The interface 220 can download media for the quoted segment when the timer 312 matches a time, or a location, of a quote insertion time. The media can be fed into the second podcast at a time corresponding to a quote insertion time. Alternatively, the media can be fed into the second podcast via a linked download. For example, the specification includes an Internet Protocol (IP) address of a website that hosts the quoted segment. The quoted segment can be streamed from the website during delivery of the second podcast. Understandably, the presentation of the quoted segment corresponds to the quote insertion time. However, the interface 220 may begin download or prepare for download prior to the quote presentation time. For example, there may be a delay associated with decompressing a media file, or opening a communication channel with a website hosting the quoted segment. The interface 220 can prepare the quoted segment for presentation prior to the quote insertion time for ensuring the quoted segment is included in the second podcast at the scheduled time.

In the event the interface 220 is unable to decompress or retrieve the media for the quoted segment, the interface 220 can specify a quote segment duration of zero. The interface 220 can interpret a quote segment duration of zero as an indication that the quote segment is unavailable, or missing. Accordingly, the interface 220 can play a brief tone or message to indicate that a quote segment should be played, though is missing. In one aspect, the interface 220 can provide information to the user such as the IP address for allowing the user to investigate the source of the quoted segment. At step 444 the method can end.

In another arrangement, the mobile device 160 can extract and play back quoted segments saved in the quote insertion list. For example, the list of quote insertion times can be presented on the display 210 (See FIG. 3). The list of quotes can be presented in a scrollable list from which the user can select one or more of the quoted segments. The quoted segments may be part of existing podcasts. The mobile device can retrieve the podcasts and extract the quoted segment from the podcasts. The quoted segments can be saved to a file and played back to the user.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for podcast quoting, comprising:
creating a specification for a quoted segment; and
inserting the quoted segment into a podcast in accordance with the specification,
wherein the specification includes information for inserting the quoted segment into the podcast.

2. The method of claim 1, further comprising:
identifying a media source of the quoted segment;
marking a start time of the quoted segment;
marking an end time of the quoted segment; and
including a reference to the media source, the start time, and the end time in the specification,
wherein the reference is a Universal Resource Indicator (URI), a hyper transfer text protocol (HTTP) address, or an Internet Protocol (IP) address.

3. The method of claim 1, wherein the creating the specification further comprises:
scanning the specification for a list of quote insertion times;
determining one or more insertion points into the podcast based on the list of quote insertion times; and
inserting one or more quoted segments in the podcast at the one or more insertion points.

4. The method of claim 1, wherein the specification is included as meta data within the podcast or as a media file.

5. The method of claim 2, wherein the inserting the quoted segment further comprises:
extracting media from the media source at a start time and an end time given in the specification;
determining an insertion point into the podcast, wherein the insertion point is given in the specification; and
feeding the media into the podcast at the insertion point for providing the quoted segment.

6. The method of claim 1, wherein the creating the specification further comprises creating a list of quote insertion times corresponding to one or more insertion points in the podcast.

7. The method of claim 1, wherein the inserting the quoted segment further comprises:
retrieving a list of quote insertion times;
tracking a time during the delivery of the podcast;
comparing the time with the list of the quote insertion times; and
inserting the quoted segment when the time corresponds to a quote insertion time.

8. A method for inserting selected media in a podcast, comprising:
quoting a segment of a first podcast for creating a quoted segment;
creating a specification for the quoted segment;
inserting the specification into a feed of a second podcast; and
activating the specification during a delivery of the second podcast, wherein the specification instructs a rendering of the quoted segment during a feed of media to the second podcast.

9. The method of claim 8, wherein the activating further comprises:
contacting a source that provides a media of the quoted segment;
acquiring the media from the source; and
presenting the media at an insertion point in the second podcast in accordance with the specification.

10. The method of claim 9, wherein the specification identifies the source, a start time of the media, an end time of the media or a time length of the media.

11. The method of claim 9, wherein the media is extracted from a text file, an image file, a video, or an audio file referenced by the first podcast.

12. The method of claim 9, wherein the acquiring a media includes pulling down one or more XML files containing an Internet address for one or more media files.

13. The method of claim 8, further comprising:
feeding the quoted segment from a source of the first podcast to a source of the second podcast,
wherein the source can identified from a Universal Resource Indicator (URI), a hyper transfer text protocol (HTTP) address, or an Internet Protocol (IP) address.

14. A mobile device for podcast quoting, comprising:
a media display for presenting a podcast; and
an interface for inserting a quoted segment into the podcast in accordance with a specification;
wherein the specification instructs a feeding of the quoted segment into the podcast.

15. The mobile device of claim 14, further comprising:
an address bar for entering in an address of a podcast; and
a selector having at least a begin quote insertion time selection, an end quote insertion time selection, and an insert quote segment selection,
wherein the selector marks a begin capture point and an end capture point for extracting the quoted segment and saving the quoted segment.

16. The mobile device of claim 15, wherein the selector marks an insertion point for inserting the quoted segment into a podcast.

17. The mobile device of claim 14, wherein the media unit further includes:
a communications unit having a transmit module and receive module for receiving media and presenting the one or more podcasts,
wherein the communication unit supports packet data and establishes a communication link to one or more media sources providing a connection through a Universal Resource Indicator (URI), a hyper transfer text protocol (HTTP) address, or an Internet Protocol (IP) address.

18. The mobile device of claim 16, further comprising a processor for
retrieving a list of quote insertion times;
tracking a time during a delivery of the second podcast;
comparing a time with the list of quote insertion times; and
inserting the quoted segment when the time corresponds to a quote insertion time, wherein the quoted segment is the portion.

19. The mobile device of claim 18, wherein the processor retrieves media from one or more sources for inserting the quoted segment, and if the processor cannot retrieve the media, the processor assigns a quoted segment duration of zero to indicate a missing portion.

20. The mobile device of claim 18, wherein the processor creates a media file for storing the quoted segment in response to a quote request by the interface unit
